(19) United States
(12) Patent Application Publication
(10) Pub. No.: US 2008/0117229 A1
(43) Pub. Date: May 22, 2008

(54) Linked Data Series Alignment System and Method

(76) Inventors: Rainer Wegenkittl, Sankt Poelten (AT); Donald K. Dennison, Waterloo (CA); John J. Potwarka, Waterloo (CA); Lukas Mroz, Wien (AT); Armin Kanitsar, Wien (AT); Gunter Zeilinger, Wien (AT)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/562,521

(22) Filed: Nov. 22, 2006

(51) Int. Cl. G06T 3/20

(52) U.S. Cl. 345/619

(57) ABSTRACT

A linked image display system and method for synchronizing two or more image series by setting any number of synchronization points and interpolating between these points. The synchronization points may either be selected automatically or by allowing the user to navigate through the image series to select corresponding images. Once the synchronization points have been selected, the image series may be linked and navigated in tandem.

### FIELD

The embodiments described herein relate to an image viewing system and method and more particularly to a system and method for aligning series of images to be viewed in tandem.

### BACKGROUND

Commercially available image display systems in the medical field utilize various techniques to present image data to a user. Specifically, image data produced within modalities such as Computed Tomography (CT), Magnetic Resonance (MR) and the like is displayed on a display terminal for review by a medical practitioner at a medical treatment site. This image data is used by the medical practitioner to determine the presence or absence of a disease, tissue damage, etc. Through visual comparisons with prior imaging studies, medical practitioners are able to make or improve diagnoses based on changes in a patient's imaging studies over time.

In order to compare one imaging study with one or more previous imaging studies or with current studies from a different modality, the studies may be linked such that, as a medical practitioner navigates through the images of the first study, the images of the other studies will change accordingly. For example, a medical practitioner may wish to scroll through a series of MR images and, at the same time, scroll through a series of previous MR images which have the same orientation in order to observe the development of a pathology.

Modalities such as CTs capture a series of images (or image series) by moving the table on which the patient lies through the image capturing device as the images are being captured. Modalities such as MRs, on the other hand, capture images by moving the image capturing device around the stationary patient. Which ever way the modality functions to capture an image series, each image will have an associated image position representing the position/orientation of the image within a three dimensional coordinate system.

Each image series may be very different in terms of the spacing between the images, the patient's position on the table, etc. In order to correct for these differences, most systems today let the user identify one image in each examination (a synchronization point) which shows exactly the same portion of the body and, from those images, the system synchronizes the data sets by the image positions of the images. This method is only sufficient, however, so long as the patient did not change his or her size synchronization to image position during the data capture. Even if the synchronization point is correctly selected, due to movements of the patient (such as breathing and stretching), the image series may no longer be synchronized as the user navigates farther from the synchronization point. Thus, there is a need for a system that will effectively synchronize the imaging studies throughout the image series.

### SUMMARY

The embodiments described herein provide in one aspect, a method for aligning a first image series with a second image series wherein each images series contains a plurality of images and each image is associated with an image position, the method comprising:
(a) selecting a first set of at least two pairs of image positions wherein the first image position of each first set of image position pairs is the position of an image from the first image series and the second image position of each first set of image position pairs is the position of a corresponding image from the second image series;
(b) determining a first interpolation function using the first set of image position pairs; and
(c) associating a first image in the first image series with a second image in the second image series wherein the image position of the second image is determined by applying the interpolation function to the image position of the first image.

The embodiments described herein provide in another aspect, a system for aligning a first image series with a second image series wherein each images series contains a plurality of images and each image is associated with an image position, the system comprising:
(a) a memory for storing the first image series and the second image series;
(b) a processor coupled to the memory, said processor configured for:
   (I) selecting a first set of at least two pairs of image positions wherein the first image position of each first set of image position pairs is the position of an image from the first image series and the second image position of each first set of image position pairs is the position of a corresponding image from the second image series;
   (II) determining a first interpolation function using the first set of image position pairs; and
   (III) associating a first image in the first image series with a second image in the second image series wherein the image position of the second image is determined by applying the interpolation function to the image position of the first image.

Further aspects and advantages of the embodiments described will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an exemplary embodiment of a linked image display system for synchronizing two or more image series;

FIG. 2 is a schematic diagram of an exemplary embodiment of the diagnostic and non-diagnostic interfaces of FIG. 1;

FIG. 3 is a flowchart diagram illustrating the process steps conducted by the linked image display system of FIG. 1;

FIGS. 4A and 4B are schematic diagrams of the diagnostic interface of FIG. 2 featuring two linked images;

FIG. 5 is a schematic diagram illustrating the setting of a first synchronization point; and

FIG. 6 is a schematic diagram illustrating the setting of a second synchronization point.

It will be appreciated that for simplicity and clarity of illustration, elements shown in the figures have not necessarily been drawn to scale For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

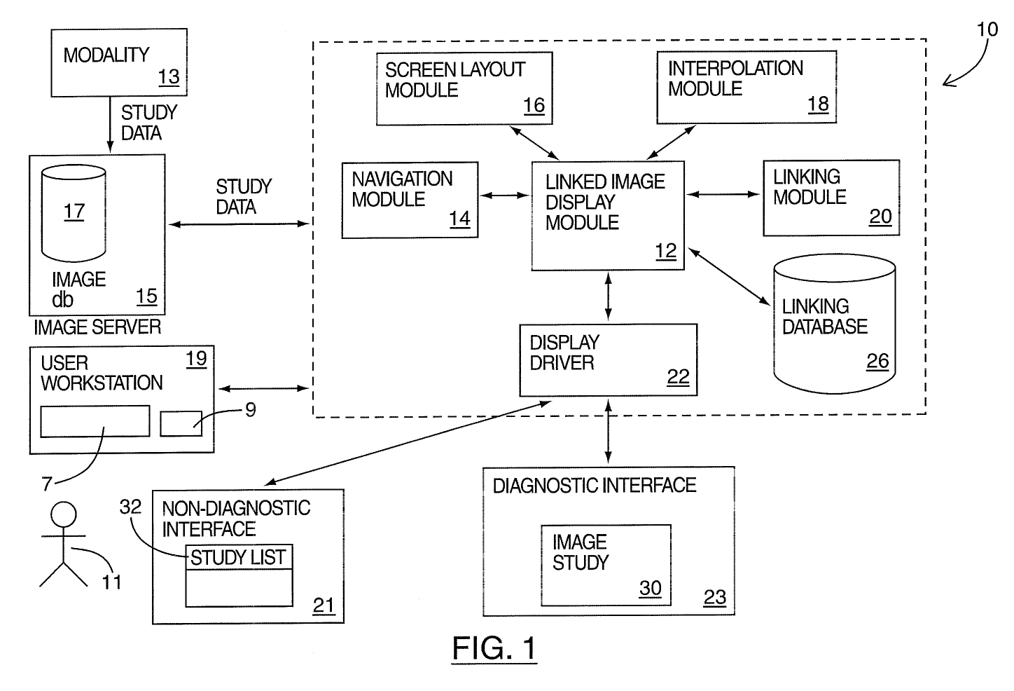

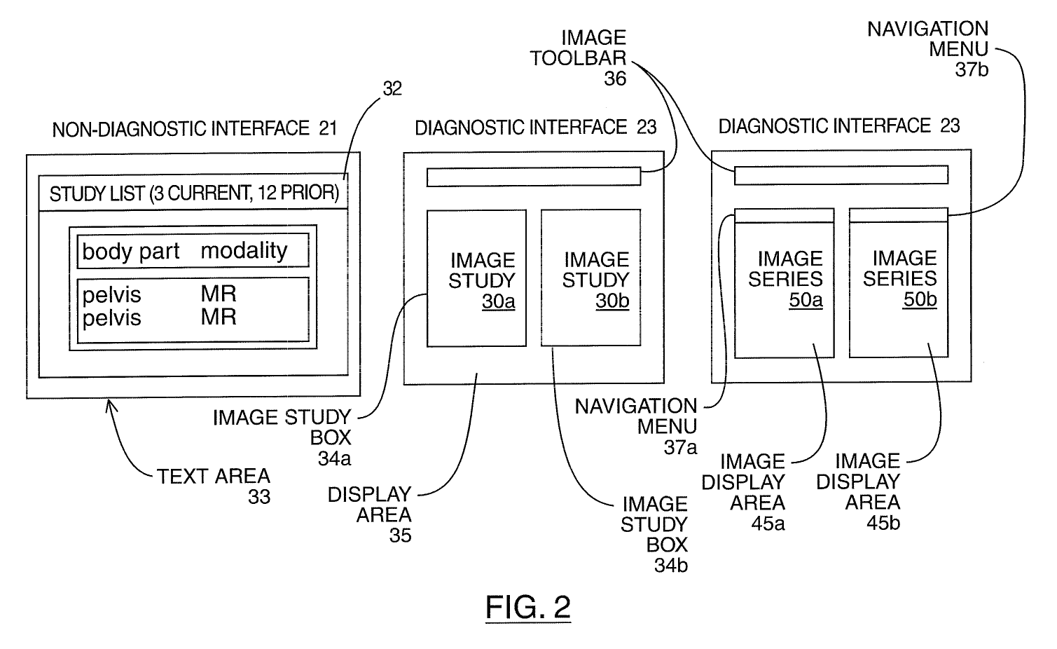

Reference is first made to FIGS. 1 and 2, which illustrate an exemplary embodiment of a linked image display system 10. Linked image display system 10 includes a linked image display module 12, a navigation module 14, a screen layout module 16, an interpolation module 18, a linking module 20, a display driver module 22 and a linking database 26. Linked image display system 10 is used to synchronize and display two or more image series together on a diagnostic interface(s) 23. Linked image display system 10 accomplishes image series synchronization by allowing user 11 to set any number of synchronization points and interpolating these points to synchronize the entire image series. While image display system 10 will be discussed with reference to two image series 50a and 50b from two image studies 30a and 30b, it should be understood that any number of image series from any number of image studies could be synchronized and displayed.

As discussed in more detail above, it should be understood that image display system 10 may be implemented in hardware or software or a combination of both. Specifically, the modules of image display system 10 are preferably implemented in computer programs executing on programmable computers each comprising at least one processor, a data storage system and at least one input and at least one output device. Without limitation the programmable computers may be a mainframe computer, server, personal computer, laptop, personal data assistant or cellular telephone. In some embodiments, image display system 10 is implemented in software and installed on the hard drive of user workstation 19 and on image server 15, such that user workstation 19 interoperates with image server 15 in a client-server configuration. In other embodiments, the image display system 10 can run from a single dedicated workstation that may be associated directly with a particular modality 13. In yet other embodiments, the image display system 10 can be configured to run remotely on the user workstation 19 while communication with the image server 15 occurs via a wide area network (WAN), such as through the Internet.

Modality 13 is any conventional image data generating device (e.g. computed radiography (CR) systems, computed tomography (CT) scanners, magnetic resonance imaging (MRI) systems, positron emission tomography (PET), ultrasound systems, etc.) utilized to generate image data that corresponds to patient medical exams. The image data generated by modality 13 is then utilized for making a diagnosis (e.g. for investigating the presence or absence of a diseased part or an injury or for ascertaining the characteristics of the diseased part or the injury).

Modalities 13 may be positioned in a single location or facility, such as a medical facility, or may be remote from one another. Image data from modality 13 is stored within image database 17 within an image server 15 as conventionally known.

Modalities 13 such as CTs and PETs capture an image series by moving the table on which the patient lies through the image capturing device as the images are being captured. Modalities 13 such as MRs, on the other hand, capture images by moving the image capturing device around the stationary patient. Which ever way the modality 13 functions to capture an image series, each image will have an associated image position representing the position/orientation of the image within a three dimensional coordinate system. In the following examples we will assume that modality 13 is a CT and that the two image series to be linked are coplanar. As such they may be linked using a two dimensional coordinate such as table position (that is the position which the table was in when the image was captured). However, it should be understood that any image position variable could be used for this purpose.

User workstation 19 includes a keyboard 7 and a user pointing device 9 (e.g. mouse) as shown in FIG. 1. It should be understood that user workstation 19 can be implemented by any wired or wireless personal computing device with input and display means (e.g. conventional personal computer, laptop computing device, personal digital assistant (PDA), etc.) User workstation 19 is operatively connected to non-diagnostic interface 21 and diagnostic interface 23. Linked image display system 10 is used to allow user 11 to navigate through two or more image series together using user workstation 19 and user pointing device 9. As discussed above, in one exemplary embodiment, the modules of linked image display system 10 are preferably installed either on the hard drive of user workstation 19 and/or on a central image server 15 such that user workstation 19 interoperates with central image server 15 in a client-server configuration.

Non-diagnostic interface 21 provides a user with an image study list 32 that provides a textual format listing of image studies 30 available for display. Image study list 32 also includes associated identifying indicia (e.g. body part, modality, etc.) and organizes image studies 30 into current and prior image study categories. Typically, user 11 will review image study list 32 and select one or more image studies 30 for display on diagnostic interface 23. Other associated textual information (e.g. patient information, image resolution quality, date of image capture, etc.) is simultaneously displayed within image study list 32 to assist the user 11 in selection of image studies 30. Non-diagnostic interface 21 is preferably provided by a conventional color computer monitor (e.g. a color monitor with a resolution of 1024×768) with sufficient processing power to run a conventional operating system (e.g. Windows NT).

Diagnostic interface 23 is preferably provided by a display that provides a high-resolution image display of image studies 30a and 30b to user 11. As shown in FIG. 2, image studies 30a and 30b are preferably displayed within image study boxes 34a and 34b respectively defined within a display area 35 of diagnostic interface 23. Image tool bars 36 allow the user 11 to control presentation of the images. Image series 50a and 50b from image studies 30 can be displayed in image display areas 45a and 45b. The image series 50a and 50b may be navigated using navigation menus 37a and 37b.

Diagnostic interface 23 is preferably provided using medical imaging quality display monitors with relatively high resolution typically used for viewing CT and MR image studies (e.g. black and white “reading” monitors with a resolution of 1280-1024 and up). Diagnostic interface 23 provides high resolution image display of display entities (e.g. image studies 30) to user 11. Diagnostic interface 23 is preferably provided by a medical imaging quality display monitor with a relatively high resolution typically used for viewing CT and MR image studies (e.g. black and white “reading” monitors with a resolution of 1280-1024 and up). While image display system 10 will mainly be discussed in respect of one diagnostic interface 23, it should be understood that image display system 10 can be adapted to display image studies 30 on any supported number of diagnostic interfaces 23.

Display driver 22 is a conventional display screen driver implemented using commercially available hardware and software. Display driver 22 ensures that image studies 30a and 30b and image series 50a and 50b are displayed in a proper format on diagnostic interface 23.

Linked image display module 12 coordinates the activities of navigation module 14, screen layout module 16, interpolation module 18, and linking module 20 in response to user commands sent by user 11 from user workstation 19 and manages data within the linking database 26. Linked image display module 12 is adapted to display two images series 50a and 50b together on diagnostic interface 23 as shown in FIG. 2.

Screen layout module 16 is used to display the images series 50a and 50b in the desired order, arrangement and format on diagnostic interface 23. In FIG. 2, the image series 50a and 50b are shown displayed side by side but it should be understood that the image series 50a and 50b may be displayed in any configuration. Furthermore, although reference will be made to only two image series 50a and 50b, it should be understood that the method described can be generalized to handle any number of image series 50a and 50b from any number of image studies 30.

Navigation module 14 is used to allow user 11 to navigate through the image series 50a and 50b by determining which image is to be displayed next in response to input from user 11. Before the image series 50a and 50b are linked, each image series 50a and 50b can be navigated individually using navigation menus 37a and 37b. Once the image series 50a and 50b are linked, however, they will be navigated together.

In order to set a synchronization point, user 11 must first unlink the image series 50a and 50b, if they are linked, and navigate through each image series 50a and 50b individually using navigation menus 37a and 37b to find two corresponding images. Once user 11 has navigated to and selected a pair of corresponding images, linking module 20 is used to create a synchronization point which will be stored in linking database 26. This procedure can be repeated multiple times to establish multiple synchronization points.

Once one or more synchronization points have been established and the image series 50a and 50b have been linked, interpolation module 18 is used to determine an interpolation function based on the established synchronization points. In the examples that follow, we will assume that interpolation module 18 employs linear interpolation but it should be understood that any type of interpolation (e.g. polynomial interpolation, spline interpolation, etc.) may be used. As user 11 navigates through the pair of image series 50a and 50b in tandem, the interpolation function is used to determine which pairs of images should be displayed together in image display areas 45a and 45b.

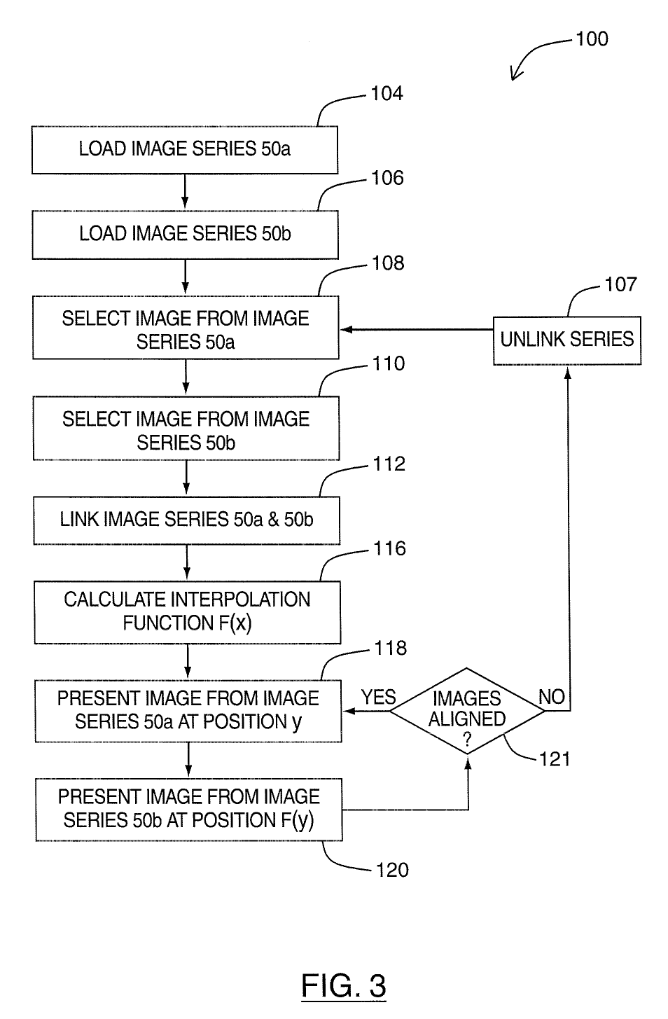

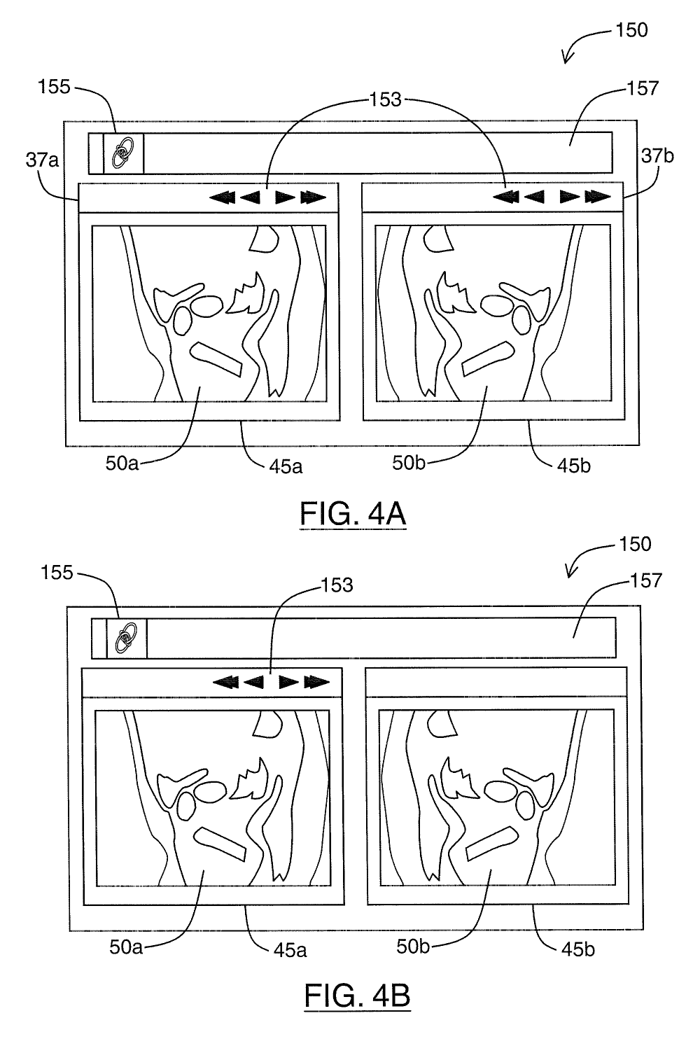

Referring now to FIGS. 1, 2, 3, 4A and 4B, the basic operation of linked image display system 10 is illustrated. Specifically, FIG. 3 is a flowchart diagram that illustrates the basic operational steps 100 of linked image display system 10. FIGS. 4A and 4B are schematic diagrams that each illustrate a simplified example diagnostic interface 150 used to link the two image series 50a and 50b and to navigate through the image series 50a and 50b in tandem.

At steps (104) and (106), image series 50a and image series 50b are loaded into display areas 45a and 45b respectively. User 11 may then select an image from each image series 50a and 50b at steps (108) and (110) as corresponding images that will be used as an initial synchronization point. FIG. 4A shows a diagnostic interface 150 with images from two image series 50a and 50b displayed side by side. As the two image series 50a and 50b are not currently linked, each can be navigated individually using navigation buttons 153 associated with navigation menus 37a and 37b.

Once the corresponding images to be synchronized are selected, the synchronization point is set and the image series 50a and 50b are linked at step (112) using linking button 155 on linking toolbar 157 (FIG. 4A).

FIG. 4B shows the diagnostic interface 150 after the two image series 50a and 50b have been linked using linking button 155. Now both image series 50a and 50b may be navigated together using a single set of presented navigation buttons 153.

Referring back to FIG. 3, at step (116), an interpolation function F(x) is calculated based on the selected synchronization point(s). In the examples that follow, linear interpolation is used but it should be understood that any type of interpolation could be employed. Assuming the image position variable used is the table position, as user 11 navigates through the two image series 50a and 50b in tandem, if an image from image series 50a with table position y is displayed in image display area 45a at step (118), then the image from image series 50b with table position F(y) (or the closest image thereto) will be presented in the image display area 45b at step (120).

As the user 11 navigates farther from the synchronization point, the image series 50a and 50b may again become misaligned, usually due to movement of the patient during image capture. In this case, user 11 or linked image display system 10 at step (121) may determine that further synchronization points should be established and operational steps 100 will proceed from step (121) back to step (107). At step (107), the image series are unlinked (by re-selecting button 155 in FIG. 4B) so that they can be navigated individually and another synchronization point can be selected. After the image series 50a and 50b are re-linked at step (112), the interpolation function is again calculated at step (116) based on the synchronization points which have been selected so far and the images series 50a and 50b are again navigated in tandem at steps (118) and (120).

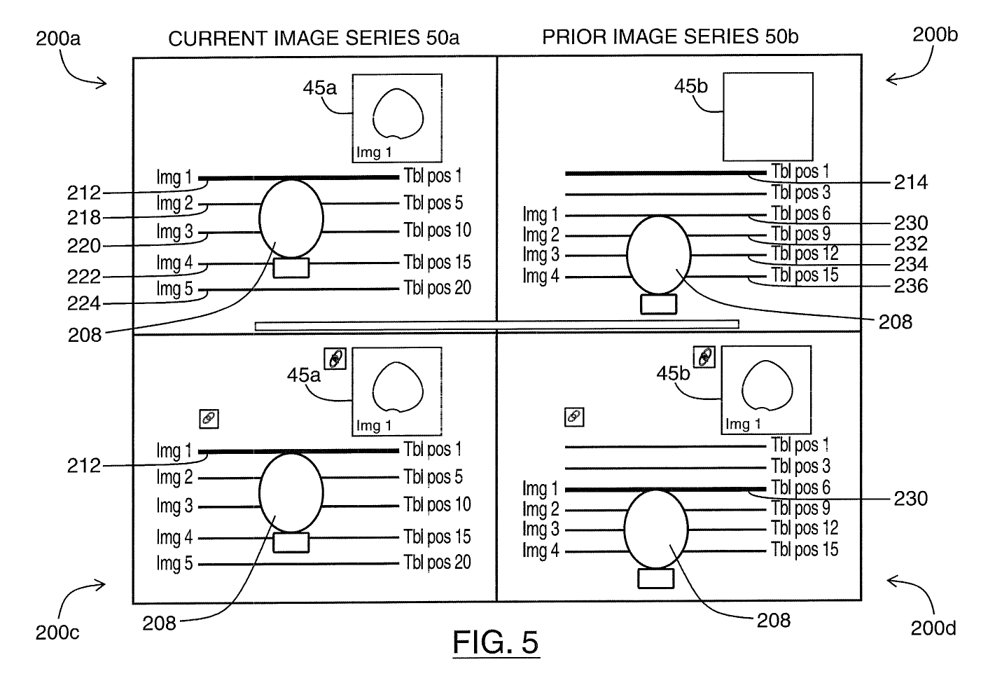

Referring now to FIG. 5, a schematic diagram illustrates the setting of a first synchronization point for two image series, current image series 50a and prior image series 50b, of a patient's head 208. The image series 50a and 50b have been captured using a modality such as a CT in which the image capturing device remains stationary as the table on which the patient is secured moves beneath it. We will assume that the image series are coplanar such that the position of each image can be described by the position of the table when the image was captured. Five images have been captured of a patient's head 208 for the current image series 50a and four images of the same patient's head 208 had been captured for a prior image series 50b. In order to allow the user 11 to navigate through these two image series 50a and 50b in tandem, the image series 50a and 50b must be synchronized.

Diagrams 200a and 200b represent image series 50a and 50b, respectively, before a synchronization point has been set. In diagram 200a, the five images captured for image series 50a are represented by horizontal lines 212, 218, 220, 222, and 224 with the examination table position from which the image was captured indicated on the right hand side. For example, the first image, represented by line 212, was taken when the table was at position 1. The second image, represented by line 218, was taken when the table was at position 5, etc. The first image, showing the top of head 208, is the image currently being displayed in image display area 45a as indicated on diagram 200a by the fact that line 212 is bold.

In diagram 200b, the four images captured for prior image study 227 are represented by lines 230, 232, 234, and 236. These images were captured at table positions 6, 9, 12, and 15, respectively. In this case and as shown, the first image was not captured until the table was in position 6. Table position 1, represented by line 214, is not associated with an image.

Diagrams 200c and 200d represent image series 50a and 50b after one synchronization point has been set. Diagram 200c shows image series 50a again displaying the image from table position 1 in image display area 45a. In diagram 200d, the user has navigated through the image series 50b to the image from image series 50b at table position 6 which is the image most closely matching the image at table position 1 from image series 50a. The image at table position 6, represented by line 230, is displayed in image display area 45b.

After the image series 50a and 50b have been linked, the user may navigate both image series 50a and 50b simultaneously. Since only one synchronization point has been set, the interpolation function will simply be an offset of five,. In other words, an image from image series 50a will always be displayed alongside the image from image series 50b at the same table position plus five (i.e. F(x)=x+5). For example, if the user navigates to the third image in image series 50a which is at table position 10, that image will be displayed in image display area 45a alongside the image from image series 50b at table position 15, or the closest image to table position 15 (in this case the image represented by line 236), in display area 45b.

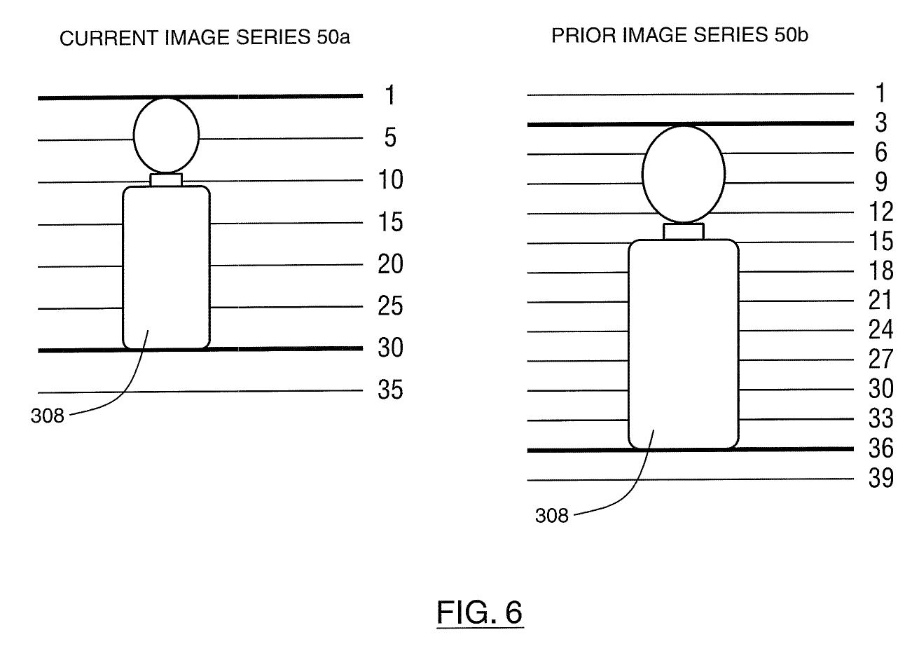

Referring now to FIGS. 1, 2, 3, and 6, another schematic diagram is shown illustrating two image series, current image series 50a and prior image series 50b, of a subject's head and torso 308. The image series have been captured using a modality such as a CT in which the image capturing device remains stationary as the table on which the patient is secured moves beneath it.. We will assume that the image series are coplanar such that the position of each image can be described by the position of the table when the image was captured. The first image of image series 50a was taken at table position 1 and the first image of image series 50b was taken at table position 3.

In this example, at steps (108) and (110), the image from image series 50a at table position 1 and the image from image series 50b at table position 3 are selected as a first set of corresponding images. The image series 50a and 50b are then linked at step (112). In this case, the interpolation function calculated at step (116) will be F(x)=x+2. The user 11 may then scroll through the images from both image series 50a and 50b in tandem. For example, if the image from image series 50a at table position 15 were presented in image display area 45a at step (118) then the image from image series 50b that is closest to table position 17 (in this case the image at table position 18) will be presented in image display area 45b at step (120).

If the user 11 continues to navigate down the torso, however, they will reach the point where the image of image series 50a at table position 30 is displayed alongside the image of image series 50b at table position 32. At this point, the images are no longer properly aligned as the image of image series 50a at table position 30 shows the very end of the head and torso 308 whereas the image of image series 50b at table position 32 does not. The user 11 may decide to set a second synchronization point at step (121), unlink the image series 50a and 50b at step (107), and then select another synchronization point by selecting a set of corresponding images at steps (108) and (110). For example, the user 11 may select the image from image series 50a at table position 30 and the image from image series 50b at table position 36. The image series 50a and 50b are then re-linked at step (112).

An interpolation function F(x) is then calculated at step (116) based on the selected synchronization points. Many different types of interpolation methods could be used to calculate F(x) but in the present exemplary embodiment it will be assumed that linear interpolation is used so that:

F(x)=yₐ+(x−xₐ)(y_{b}−yₐ)/(x_{b}−xₐ);

where in this example, (xₐ,yₐ)=(1,3) and (x_{b},y_{b})=(30,36).

Thus, for example, if the image from image series 50a at table position 20 is presented in image display area 45a at step (118) then F(x)=24.6 and the image from image series 50b at the table position closest to 24.6 (in this case the image at table position 24) will be displayed in image display area 45b at step (120).

In the preceding examples, it has been assumed that it is the user 11 who determines which synchronization points will be used to link the image series but it should be understood that these points may be selected automatically using systems which are capable of detecting certain points in the human body.

In another exemplary embodiment of the present invention, the second image series 50b could be a type of atlas image series representing the proportions of standard human being with normalized height. In this embodiment, any number of image series could be globally synchronized with the atlas image series and this information could be used such that any two of the image series could be navigated together without the need to set any further synchronization points.

In one embodiment, the synchronization of a number of image series to an atlas image series is accomplished by normalizing the height of a human being in percent terms and using this, along with the table positions of the image series, to map points from the image series to the atlas image series 50b. For example, the toe of the atlas image series 50b could be at 0 percent and the top of the head could be at 100 percent, the centre of the L1 vertebra could be at 50 percent, the lower jaw could end at 85 percent, the lungs could start at 79 percent, etc.

When a new image series 50a is acquired, the system could either automatically detect landmark points or a technician could manually highlight some landmark points to be used as synchronization points. For example, parts of the human anatomy such as vertebrae can be automatically detected and this information can be used to mark that an image at a certain table position of the new image series 50a shows the centre of the L1 vertebra and, hence, corresponds to 50 percent in the atlas image series 50b.

Whenever two image series 50a and 50c which have both been synchronized to an atlas image series 50b have to be synchronized with each other, the atlas image series 50b may be used to determine which image of the image series 50c corresponds to a chosen image in the image series 50a by mapping through the atlas image series 50b. In other words, the chosen image from the image series 50a can be mapped to an “image” in the atlas image series 50b and then the atlas “image” can be mapped to the image in the image series 50c. If the synchronization was done correctly, the image in the image series 50c will correspond to the chosen image from the image series 50a.

It should be noted that the landmark points used to synchronize the image series 50a to the atlas image series 50b do not need to be the same as the landmark points used to synchronize the image series 50c with the atlas image series 50b. As long as all the points are properly selected, the mapping will be successful.

In many instances, synchronizing an image series with an atlas image series 50b using a single landmark point would be sufficient if only patients of similar height are compared using an atlas of similar height. However, having multiple landmark points within the patient and interpolating between these landmark points greatly improves the quality of synchronization and hence, it is recommended that at least two landmark points be set.

While the various exemplary embodiments of the linked image display system 10 have been descried in the context of medical image management in order to provide an application-specific illustration, it should be understood that the linked image display system 10 could also be adapted to any other type of image or document display system.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method of aligning a first image series with a second image series wherein each images series contains a plurality of images and each image is associated with an image position, the method comprising:
(a) selecting a first set of at least two pairs of image positions wherein the first image position of each first set of image position pairs is the position of an image from the first image series and the second image position of each first set of image position pairs is the position of a corresponding image from the second image series;
(b) determining a first interpolation function using the first set of image position pairs; and
(c) associating a first image in the first image series with a second image in the second image series wherein the image position of the second image is determined by applying the interpolation function to the image position of the first image.

2. The method of claim 1, further comprising displaying the first image and the second image.

3. The method of claim 1, wherein the at least two pairs of image positions are automatically selected.

4. The method of claim 1, wherein the second image series is an atlas image series representing the normalized proportions of at least a portion of a human body.

5. The method of claim 4, for linking a third image series with the first image series, wherein, after (c), the method further comprises:
(d) selecting a second set of at least two pairs of image positions wherein the first image position of each second set of image position pairs is the position of an image from the atlas image series and the second image position of each second set of image positions pairs is the position of an image from the third image series;
(e) determining a second interpolation function using the second set of image position pairs; and
(f) associating a third image in the first image series with a fourth image in the third image series wherein the position of the fourth image is determined by applying the first interpolation function to the position of the third image to get a position of a fifth image in the atlas image series and applying the second interpolation function to the position of fifth image.

6. A computer-readable medium upon which a plurality of instructions are stored, the instructions for performing the steps of the method as claimed in claim 1.

7. A linked image display system for aligning a first image series with a second image series wherein each images series contains a plurality of images and each image is associated with an image position, the system comprising:
(a) a memory for storing the first image series and the second image series;
(b) a processor coupled to the memory, said processor configured for:
(I) selecting a first set of at least two pairs of image positions wherein the first image position of each first set of image position pairs is the position of an image from the first image series and the second image position of each first set of image position pairs is the position of a corresponding image from the second image series;
(II) determining a first interpolation function using the first set of image position pairs; and
(III) associating a first image in the first image series with a second image in the second image series wherein the image position of the second image is determined by applying the interpolation function to the image position of the first image.

8. The system of claim 7, wherein the processor is further adapted to display the first image and the second image.

9. The system of claim 7, wherein the at least two pairs of image positions are automatically selected.

10. The system of claim 7, wherein the second image series is an atlas image series representing the normalized proportions of at least a portion of a human body.

11. The system of claim 10, for linking a third image series with the first image series, wherein, after (III), the processor is further adapted to:
(IV) select a second set of at least two pairs of image positions wherein the first image position of each second set of image position pairs is the position of an image from the atlas image series and the second image position of each second set of image positions pairs is the position of an image from the third image series;
(V) determine a second interpolation function using the second set of image position pairs; and
(VI) associate a third image in the first image series with a fourth image in the third image series wherein the position of the fourth image is determined by applying the first interpolation function to the position of the third image to get a position of a fifth image in the atlas image series and applying the second interpolation function to the position of fifth image.
